(19) United States
(12) Patent Application Publication
(10) Pub. No.: US 2006/0070249 A1
(43) Pub. Date: Apr. 6, 2006

(54) Tool for efficient setting of grading height

(76) Inventors: Garrett Wallach, Bethlehem, PA (US); Anthony Chase, Dublin, PA (US)

Correspondence Address: Garrett Wallach, 1335 Center Street, Bethlehem, PA, 18018, US

(21) Appl. No.: 10/958,781

(22) Filed: Oct. 5, 2004

(51) Int. Cl. G01D 21/00

(52) U.S. Cl. 33/1 G

(57) ABSTRACT

This invention relates generally to a tool for setting grading heights and more particularly to a tool for rapid and efficient measurement of grading heights between adjacent or opposing edges. Briefly stated, the preferred embodiment of the present invention consists of two grading pins spaced apart from each other and inserted into the surface adjacent where grading measurements are desired. Slidably disposed on one of the grading pins is a line casing having a spring loaded retractable string therein with the string having a hook on one end whereby the string is effectively stretched between the two grading pins. Thereafter the string is used as a reference line in order to determine the desired grade height.

### BACKGROUND OF THE INVENTION

This invention relates generally to a tool for setting grading heights and more particularly to a tool for rapid and efficient measurement of grading heights between adjacent or opposing edges.

Engineering and construction crews frequently have to set grading heights and thickness for various surfaces such as roadways, driveways, walkways and the like. Moreover, these heights or thicknesses must be determined a number of times during the course of their construction, specifically as each layer of sub base and base material (e.g. gravel) are deposited and perhaps compacted, and once again as the finish material is placed. Such finish materials may include asphalt, macadam, concrete, paving bricks or even fine or small size stones.

Additionally, although the surfaces may be intentionally laid so as to be level and flat, it is frequently desirous to provide or to intentionally construct a surface which is not level. Such times are generally when at least some pitch is necessary to ensure that water flows away from the surface or intentionally toward a specific area of the surface (e.g. a drain). In such cases, many techniques such as crowning or pitching are utilized.

A number of devices have been designed to aid in setting such grades. U.S. Pat. No. 2,149,360 to Prout and entitled “PORTABLE LINE LEVELING DEVICE” describes a pivoting stick from which a string may be extended to an opposing elevation stick. A significant disadvantage of this is the difficulty of adjusting the height of the pivoting stick since the height of the pivoting portion may not be vertically adjusted. Therefore, overall height adjustment may only by done by placing the entire pivoting stick at various depths in the adjacent soil which may be particularly difficult in dense soil or gravel.

Another device for assisting in grading is described in U.S. Pat. No. 2,523,255 to Coleman entitled “SURVEYING INSTRUMENT” and describes an adjustable stake within an outer casing with a detachable string being used to stretch across the surface to be graded. Disadvantages of this device include the relative complexity and cost of construction as well as the difficulty in adjusting the vertical height.

U.S. Pat. No. 4,228,588 to Horton entitled “GRADE CHECKER” describes a telescoping rod. Disadvantages of this device include its relative complexity and difficulty in adjusting the vertical height in various soil conditions.

Additional approaches to grading height devices include U.S. Pat. No. 4,916,823 to Kunze entitled “APPARATUS FOR FACILITATING ROADWAY GRADE MEASUREMENTS” which describes a device which must be used in conjunction with curbs. As such it cannot be used during all phases of construction or where no curb is used such as in walkways and driveways.

U.S. Pat. No. 4,662,078 to Gammon et. al. entitled “CONSTRUCTION STRING REEL” and U.S. Pat. No. 5,704,131 to Courtney entitled “ADJUSTABLE PLUMB BOB AND LINE CAPABLE OF AUTOMATIC BRAKING AND RETRACTION” are principally directed to string retraction devices but fail to show how they should cooperate appropriately with grading pins.

### SUMMARY AND ADVANTAGES OF THE INVENTION

In view of the above disadvantages the present invention provides a tool for setting or measuring grading heights which is inexpensive to manufacture and is relatively uncomplicated.

Another advantage of the present invention is to provide a tool which can be used with or without the aid or alignment of curbs. A further advantage of the present invention is to provide a tool which can alternatively be used for measuring or setting grading heights for walkways, driveways or roadways.

In the preferred embodiment of the present invention two grading pins are utilized. The grading pins have at one end a handle and at the other end a point thereby allowing for easy insertion by a user such as a construction worker into the ground. The grading pins when inserted are spaced apart from each other. A line casing is slideably disposed along the axis of one of the grading pins thereby adjusting the effective height of the line casing. The line casing has contained therein a spring loaded retractable string with the string having a hook on one end whereby the string is effectively stretched between the two grading pins. Thereafter the string is used as a reference line in order to determine the desired grade height

### BRIEF DESCRIPTION OF THE DRAWINGS

Reference may be now had to the accompanying drawings of the present invention in which:

FIGS. 1B & 1C illustrate front and rear views of the preferred embodiment of the present invention while FIG. 1A shows the Grade Pin for use therein; and

FIGS. 2B & 2C illustrate front and rear views of an alternate embodiment of the present invention while FIG. 2A shows an alternate Grade Pin for use therein.

### DETAILED DESCRIPTION OF THE PREFERRED EMBODIMENT

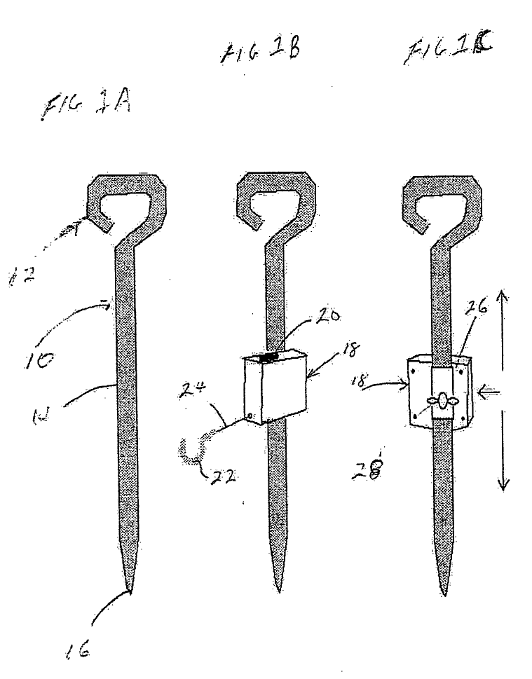

Referring to FIGS. 1A, 1B & 1C the preferred embodiment of the present invention is shown. Specifically, there is show grade pin 10 having a push handle 12 at one end, a shaft 14 and a pointed end 16 opposite the push handle 12. Grade pin 10 may be of whatever length is appropriate and may typically vary in length from 12″ to 30″, although it may be shorter or longer as desired. The grade pin 10 is preferably made of metal such as steel although it could me made of plastic or wood so long as it is of sufficient rigidity and durability.

Slideably disposed on the grade pin 10 is line casing 18. Line casing 18, in the preferred embodiment of the present invention has disposed therein a retractable string 24 which is spring loaded via a rotatable spring loading mechanism (not shown) so as to automatically retract when released. Disposed at the exposed end of string 24 is hook 22. Lever lock 20 is disposed on the outer cover of line casing 18 and when in a first position will prevent string 24 from retracting and when a second position will allow string 24 to retract into line casing 18. In this fashion it can be seen that line casing 18 functions similar to what is commonly referred to as a retractable measuring tape ruler such as those sold by Stanley Tool Works of Towson Md. or Craftsman Tools as sold by Sears of Chicago, Ill., all of which have rotatable spring loading mechanisms therein. Accordingly, lever lock 20 can be used to maintain string 24 in an extended state which may be retracted by activating lever lock 20. Further, it is to be understood that string 24 may be made of string, wire or a metal tape without departing from the spirit and scope of the present invention. As can be seen, hook 22 is shaped so as to hook onto another grade pin.

As previously recited, line casing 18 is slideably disposed on grade pin 10. Disposed on the back of the housing of line casing 18 is a sleeve 26 which extends from line casing 18 and is shaped so as to permit grade pin 10 to be disposed between the back of the housing of line casing 18 and the sleeve. Casing fastener 28, in the preferred embodiment of the present invention consists of a threaded screw having a wing nut on one end with the other end being threaded into a threaded hole in sleeve 26. In this fashion, by loosening or tightening casing fastener 28, line casing 18 may be fixed at any point along grade pin 10.

Accordingly, in use a grade pin 10 having line casing 18 disposed thereon is inserted into the ground (or gravel as appropriate) sufficiently deep so that it will not fall over. Line casing 18 is then moved vertically so that string 24 when extended will be at the desired grading height. At that point, casing fastener 28 is tightened so as to prevent further movement line casing 18. A second grade pin 10 is similarly inserted into the ground (or other material such as gravel, etc.) distally from line casing 18. String 24 is then extended so as to reach the second grade pin 10 with hook 22 then being placed onto the second grade pin 22. As such, string 24 forms a reference line from which grading or grading measurements may take place. Frequently, the user will place a line level—that is a bubble type level which is slideably disposed, along line 24 with hook 22 then being vertically adjusted so that line 24 forms a level reference line. In this fashion the user may use line 24 as a reference to determine what further grading adjustments, if any, are desirable. However, it is to be understood that line 24 does not have to be made level and therefore may be used to form a pitched or slanted grading reference line or point.

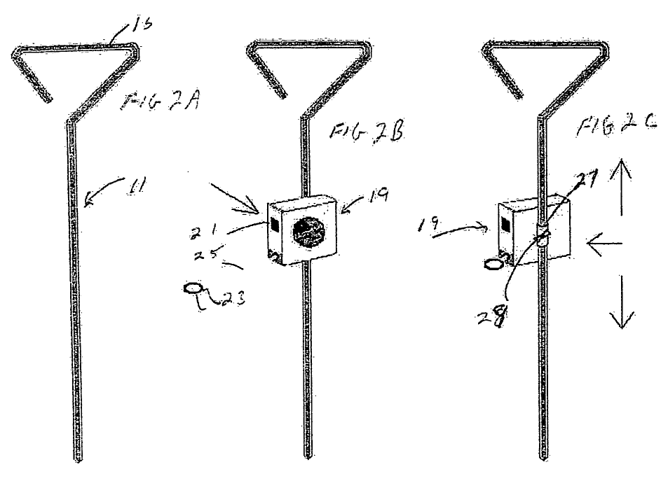

Reference may be now had to FIGS. 2A, 2B & 2C. It can be seen that this alternate embodiment is very similar to that of FIGS. 1A, 1B & 2C, functioning, except as may be described separately below in essentially the same manner. Therefore, while even numbers are used in describing FIG. 1, odd numbers are used in FIGS. 2A, 2B & 2C when such components perform in essentially the same manner as it's counterpart. As such, this alternate embodiment utilizes a grade pin 11 having a push handle 13 having a pointed end 17. Similar to FIG. 1B, FIG. 2B has slideably disposed thereon line casing 19. Line casing 19 has lever lock 21 on one edge thereof and has a retractable string 25 which extends from line casing 19 with string 25 having at the free end eyelet 23. Once a first grade pin 11 is positioned, the second grade pin 11 having line casing 19 thereon is positioned so that eyelet 23 which is attached to string 21 may be extended. Again, line casing 19 may be vertically moved along grade pin 11, fixed into place by the use of casing fastener 29 in conjunction with sleeve 27. In this fashion, string 25 may form a reference line, level or slanted as desired, which allows the user to measure or adjust the height of the surface which is being graded.

It is to be understood that the present invention may be varied in a number of ways without departing from the spirit and scope of the present. For example the push handle portion of the grade pin may be of a different shape or eliminated entirely. Similarly, the grade pin could even consist of a piece of reinforcing rod (not shown) commonly referred to as re-bar in the building industry. Also, the sleeve could have a spring loaded or interference type fit such that a threaded fastener is not required. Further, the eyelet or hook could be eliminated or changed to different shapes or even consist of a spring loaded or clothes pin type of fastener or other similar string attachment device.

What is claimed is:

1) A tool for establishing a reference line for use with grading heights, comprising:
a first grade pin;
a line casing having contained therein a rotatable spring loaded mechanism and further having a string attached thereto such that said string, once extended may be retracted by said rotatable spring loaded mechanism, said line casing being slideably disposable along the axial length of said grade pin and further having a casing fastener attached to the line casing for fixedly securing said line casing at desired positions along said axial length of said grade pin; and
a string attachment device connected to that portion of said string that is extendable from said line casing.

2) A tool according to claim 1, further comprising a second grade pin positionable so as to be apart from said first grade pin, such that said string attachment device when extended from said line casing may be fixedly secured to said second grade pin thereby allowing said string to form a reference line.

3) A tool according to claim 1 wherein said line casing has disposed thereon a lever lock for prohibiting the retraction of said string when said string has been extended from said line casing.

4) A tool according to claim 2 wherein said first and said second grade pins each have disposed at one end a handle for facilitating the insertion and extraction of said grade pins into earth.

5) A tool according to claim 2 wherein string attachment device is a hook;

6) A tool according to claim 2 wherein said string attachment device is a spring loaded clip.
